(19) United States
(12) Patent Application Publication
(10) Pub. No.: US 2002/0096570 A1
(43) Pub. Date: Jul. 25, 2002

(54) Card with a dynamic embossing apparatus

(76) Inventors: Jacob Y. Wong, Goleta, CA (US); Roy L. Anderson, Glendale, CA (US)

Correspondence Address: Roy L. Anderson, ESQ., Jeffers, Shaff & Falk, LLP, 18881 Von Karman Ave., Suite 1400, Irvine, CA, 92612, US

(21) Appl. No.: 09/771,117

(22) Filed: Jan. 25, 2001

(51) Int. Cl. G06K 19/06

(52) U.S. Cl. 235/494

(57) ABSTRACT

A card has an embossed display of user information in which at least a portion of such display is dynamically controlled. The card has an input device, such as a keypad or wireless device, a logic device, and a dynamic embossing device. The logic device generates an activation signal when the input device receives an input that satisfies an activation condition, such as correct entry of a user key. The dynamic embossing device completes the dynamic portion of the embossed display of user information in response to the activation signal. The dynamic embossing device uses individual activation mechanisms to control multiple studs readable as part of the embossed display when they are in a non-deflected position. The dynamic embossing device can use an electromagnetic force activation mechanism and an individual electromagnet to control each stud or a temperature-induced, bimetallic bending force activation mechanism and an individual bimetallic strip to control each stud. The dynamic display can be in a binary format, an alphanumeric format, or a numeric format. The embossed display of information can contain a transaction card number, such as a credit card number, which can be a user one-time card number generated by the logic device. The logic device can use the input that controls the activation mechanism, which may be a user key, or a second input to generate the one-time card number. The fixed display of user information can include a user name, which may or may not be fictitious.

### FIELD OF THE INVENTION

The present invention is in the field of cards with embossed information, and more specifically, in the field of transaction cards, such as credit and debit cards.

### BACKGROUND OF THE INVENTION

Transaction or payment cards enjoy widespread popularity throughout the world. There are literally hundreds of millions, and probably more than a billion, credit or debit cards in use throughout the world today. Such cards typically contain user information embossed in raised lettering on the front face of the card. The raised lettering usually includes the cardholder's valid account number (typically 16 digits in the United States), expiration date (4 digits) and the cardholder's full name. Additional information may also be included in raised lettering, such as length of time as a customer, frequent flier or affinity account number, etc.

It is common in millions of locations throughout the world for a merchant to make an imprint or impression of embossed information contained in a transaction card, such as a credit card. The imprint creates a paper record of information captured and read from the information embossed upon the card. The device used to make such a record is referred to as a card imprinter, and it is sometimes referred to colloquially as a “knuckle-buster.” When a card imprinter makes an imprint of a transaction card, it usually makes multiple copies of the imprint, sometimes using carbon paper to make duplicate copies, and all of the copies and carbon paper contain a copy of the pertinent user information recorded by the imprinting process. This creates an enormous potential for fraud since any one of these pieces of paper, if it is not properly handled or destroyed, can be used to perpetrate fraud through unauthorized use of the personal information contained on such copy.

Because so much user information is recorded in a permanent, readily readable manner by a card imprinter, it is easy for an unauthorized user of the card to commit fraud if the unauthorized user gains physical possession of the card or a piece of paper containing an imprint of the card. This creates the potential for fraud whenever such a card or piece of paper is stolen, lost or mishandled. In such situations, because the cardholder's embossed personal financial information has been obtained, it is possible to forge a large number of similar cards with the same cardholder's personal and financial information in them in order to commit fraudulent and unauthorized purchases, often without the prior knowledge of the cardholder.

In addition to embossed user information, transaction cards typically contain a magnetic stripe on the back face of the card, and the magnetic stripe often contains additional personal information about the cardholder. This information can be sensitive, such as a PIN number or an address. While such information is not visually discernable, a magnetic stripe reader can read it. And, unfortunately, magnetic stripe readers can be obtained by entities other than legitimate businesses, which can use them for the illegal act of “skimming”. Skimming is an unauthorized acquisition of personal and financial information about a cardholder that is stored in one or more tracks of the magnetic stripe on the backside of the card via a conventional magnetic card reader. Because magnetic card readers are readily available for purchase in the open market today, skimming is another significant tool used by thieves to commit rampant credit card fraud.

In an attempt to combat widespread credit card fraud perpetrated through use of user information available from a credit card, Wong and Anderson, in U.S. Pat. No. 5,956,699 issued in 1999, advanced a novel electronic payment method called SPECTA that resists fraud and protects privacy. SPECTA stands for “System for Processing Electronic Cash Transactions Anonymously.” Instead of using the conventional credit card number plus cardholder's name, this method uses instead a one-time valid only transaction number affiliated with the cardholder through an alias which could be the real name, an alphanumeric number or simply a digital number. In order to generate this one-time valid only transaction number, called a COUPON (which stands for “Customer One-time Unique Purchase Order Number”), one has to enter a valid PIN number (typically 4 digits) into the card through the card's keypad. In the absence of a valid PIN number, the card will not generate a valid COUPON.

In principle, the SPECTA enabled card does not require any embossed cardholder information like the credit card number, cardholder name, expiration date and other credit card association codes appearing on the card. The cardholder name and the expiration date that appear on the SPECTA enabled card are for the convenience of the cardholder but hold no significance in achieving its functional characteristics as being secure and private. The reason is that the COUPON number and the cardholder's affiliated alias reside on track 2 of the magnetic stripe. The former is always generated afresh or “on-the-fly” every time there is a new transaction. The cardholder's alias is affiliated uniquely with only the cardholder and therefore remains unchanged on track 2 of the magnetic stripe for any type of transaction.

Despite the advantages that a SPECTA enabled card offers, many merchants may be slow to adopt or accept a SPECTA enabled card that does not contain embossed cardholder information on it. For many of the merchants in the United States today that accept credit card transactions and have a magnetic card reader, it is their usual practice to both read off the cardholder information on one or more tracks of the magnetic stripe via the magnetic card reader and make an imprint of the embossed information. The reason for making the imprint is to show to the bank issuer the presence of the cardholder that is carrying out the purchase or transaction. Thus, even though the very presence of the embossed cardholder information can easily lead to both a security and privacy breach, it is an integral element of processing face-to-face credit card transactions.

Even apart from merchant reluctance to accept a credit card without embossed personal information, there are many merchants, especially outside of the United States, who do not have adequate opportunity to verify valid credit cards via telephone authorization due to inadequate telephone infrastructure. This is common in many so-called “Third World” countries, as well as in China. In fact, there is a large territorial part of China where merchants in small towns and cities still do not have a magnetic card reader and the needed communication infrastructure to conduct what is typically considered a “normal” credit card transaction in many parts of the world. Most of these merchants still rely on the card imprinter to generate the cardholder's information on a credit card form, then verify the cardholder's identification (name on the credit card with same on an ID card) and compare their signatures, but without ever receiving any approval or validation code from the issuer bank. Even though it is the merchant's responsibility to cover any fraud losses in carrying out credit card transactions this way, there is hardly any alternative to this transaction method. Thus, most such merchants will not accept a credit card that does not have the cardholder's information embossed on the card.

Accordingly, even though credit card fraud is a widespread and pervasive problem that some estimate costs billions of dollars, it still goes on. And it still goes on despite many efforts to stop it, and millions upon millions of dollars spent to combat it. Such fraud not only results in economic loss, it also results in human loss as well, in terms of lost time, frustration, peace of mind, etc., not to even mention the resources that must be spent to uncover, correct and prosecute credit card fraud. As a result, there is long-felt, crying need for an improved credit card useful in situations where a merchant does not have the technological means to seek authorization for a credit card transaction, as well as to create a suitable record of such a transaction, that provides greater security against credit card fraud. This invention addresses this need by disclosing how a dynamic embossing device can be incorporated into a conventional credit card.

### SUMMARY OF THE INVENTION

The present invention is generally directed to a card with an embossed display of user information that has an input device, a logic device that generates an activation signal when an input received by the input device satisfies an activation condition, and a dynamic embossing device for completing the embossed display of user information in response to the activation signal. The card is especially useful in the field of authenticity verification systems for use with security and financial transaction cards.

In a first, separate aspect of the present invention, the dynamic embossing device uses individual activation mechanisms to control multiple studs. The studs are readable as part of an embossed display of the card when the studs are in a non-deflected position but are not readable as part of the embossed display when they are in a deflected position. A spacer interstitially separates each pair of activation mechanisms used to control a pair of studs, and the spacer can be a physical divider or a slot. The spacer is sized so as to provide a sufficient separation of two studs separated by the spacer and ensure recognition of the two studs by a reading mechanism, such as a card imprinter, when both of the studs are in a non-deflected position. A variable spring support can be used to bias each stud toward the non-deflected position when it is in the non-deflected position and is being read by a card imprinter.

In another, separate aspect of the present invention, the dynamic embossing device uses an electromagnetic force activation mechanism and an individual electromagnet can be used to control each stud. Each electromagnet can be made of a horseshoe shaped magnetic material having an upper end with a stud located proximate to its tip, a lower end, and a winding of wires. The wires can be energized by passing electrical current through a positive and a negative terminal to cause the stud to move from the non-deflected position to the deflected position. The thickness of the upper and the lower ends of each electromagnet is such that when the lower end is secured to a rigid surface of the card so that it will not move, the upper end will deflect toward the lower, secured end.

In still another, separate aspect of the present invention, the dynamic embossing device uses a temperature-induced, bimetallic bending force activation mechanism and an individual bimetallic strip can be used to control each stud. Each bimetallic strip is individually heated by a heater, which can be a bifurcated heater, and each bimetallic strip has a stud located proximate to its tip. The heater can be a laminated polyimide electrical resistance heater, and a top part of each bimetallic strip can be bonded to the laminated polyimide electrical resistance heater. The bimetallic strips used in the activation mechanism can be formed from a single sheet of bimetallic metal such that each strip is separated from any adjacent strip so that it can move between the non-deflected position and the deflected position independent of any adjacent strip.

In yet further, separate aspects of the present invention, the card can have an embossed display of user information that includes a fixed display of user information and a dynamic display of user information activated by the dynamic embossing device in response to the activation signal. The activation condition can be that the input match a stored activation input, and the input device can be a keypad or a wireless device. The dynamic display can be in a binary format, an alphanumeric format, or a numeric format. The embossed display of information can contain a transaction card number, such as a credit card number, which can be a user one-time card number generated by the logic device. The logic device can use the input that controls the activation mechanism, which may be a user key, or a second input to generate the one-time card number. The fixed display of user information can include a user name, which may or may not be fictitious.

Accordingly, it is a primary object of the present invention to provide an improved card that has a dynamic embossing device incorporated into the card.

This and further objects and advantages will be apparent to those skilled in the art in connection with the drawings and the detailed description of the preferred embodiment set forth below.

### BRIEF DESCRIPTION OF THE DRAWINGS

FIG. 1 is a physical depiction of a front side of a transaction card that uses the present invention.

FIG. 2 is a diagram of a conventional horseshoe electromagnet having windings of electric current-carrying wires in its middle portion and an open gap at its ends.

FIGS. 3 and 4 are diagrams illustrating a portion of a preferred embodiment of the present invention that uses an electromagnetic force activation mechanism.

FIG. 5 is a diagram illustrating a portion of another preferred embodiment of the present invention that uses a temperature-induced, bimetallic bending force activation mechanism.

FIG. 6 is a system logic diagram of a microprocessor used in a preferred embodiment of the present invention.

### DETAILED DESCRIPTION OF THE PREFERRED EMBODIMENTS

In accordance with a preferred embodiment of the present invention, a card has an input device, a logic device and a dynamic embossing device. The input device can be any suitable input device, such as a keypad or a wireless device. The input device could also be something more sophisticated, such as a voice activation device or require some time of biometrics identification input. The logic device can be a computer or microprocessor, or it can be much simpler. The purpose of the logic device is to generate an activation signal when an input received by the input device satisfies an activation condition. Thus, for example, if the input is a user key, such as a Personal Identification Number (also known as a “PIN”), the logic device need only compare the input with a stored activation input and generate an activation signal if there is a match.

A card that uses the present invention may have additional elements as well, such as a power source, a magnetic storage device (such as a magnetic stripe), a display device (such as a liquid crystal display or LEDs), a computer and an encoder. Thus, for example, a preferred embodiment of the present invention could be incorporated into an electronic card of the type disclosed in U.S. application Ser. No. 09/571707 filed May 15, 2000 for Anonymous Electronic Card for Generating Personal Coupons Useful in Commercial and Security Transactions or U.S. application Ser. No. 09/667835 filed Sep. 21, 2000 for Electronic Card for Generating a New Card Number with Each Use with LED Display, the disclosures of which are specifically incorporated herein by reference.

The present invention is adapted for use in any situation in which a card conveys information that can be physically read from the card. The predominant use for such cards today is transaction cards, especially in the field of financial transactions where such cards are used as credit or debit cards (typically 3.375″×2.125″×0.048″ inclusive of the additional thickness attributable to the embossed or raised lettering).

In accordance with the present invention, information can be dynamically generated on a card such that it is readable by a card imprinter. The dynamically generated information can be displayed in any suitable format, such as numeric or alphanumeric, although it is especially preferred, for technological simplicity, to display it in a binary format. If the information is displayed in binary format, a simple optical reader can be used to convert such display into another format, such as numeric or alphanumeric. The card can contain a fixed display of user information and a dynamic display of user information and it is especially preferred, but not required, that the dynamic display be included within a fixed display of information. Thus, for example, the dynamic display might be a portion of a credit card number, such as digits 12-15, of a 16-digit credit card number. (As already noted, such digits might be represented by a binary format.)

A dynamic embossing device allows a card to create a dynamic display of information in response to entry of a correct password or activation input. The information dynamically displayed can be specific and valid data stored in either random addressable memory (RAM) or permanent or read only memory (ROM) of a microprocessor system, or it can be a specific and valid data dynamically generated by the card. The logic device can fail to activate the dynamic embossing device in response to an incorrect password or activation input. Alternatively, the logic device can generate an invalid data display in response to an incorrect password or activation input, thereby providing a mechanism for recognizing an incorrect password.

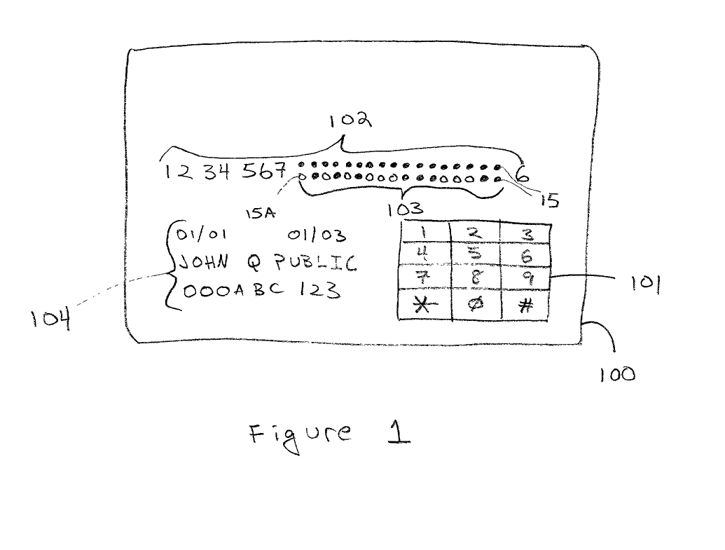

In a very simple preferred embodiment shown in FIG. 1, the card 100 is a transaction card, such as a credit card, with a magnetic stripe (on its back side, which is not shown), the same as a conventional credit card of today, but also utilizing the present invention. When a PIN is correctly entered into a keypad 101 of card 100, the logic device (not shown) activates the dynamic embossing device to fill in a dynamic display 103 of transaction card number 102. As shown in FIG. 1, the dynamic display 103 is represented by 34 binary bits of data in two rows of 17 each (which is capable of representing a ten-digit number). The top row illustrates the dynamic display 103 in an unactivated state whereas the bottom row illustrates the dynamic display 103 in an activated state (a solid circle, 15 e.g., illustrates an up position that will form an imprint and a non-shaded circle, 15A e.g., illustrates a down position that will not form an imprint). Thus, the transaction number is represented by a combination of a fixed display of user information (the first seven digits 1-7 and the 16^{th} digit 6) and a dynamic display of information (which can be used to represent digits 8 through 15 of a 16-digit card number). Card 100 also contains an additional fixed display of information 104 containing expiration date information (01/01 and 01/01), a name (JOHN Q PUBLIC), and affinity information (000ABC123).

It is preferable that card 100 contain additional security measures, such as limiting the number of false inputs before the card is deactivated or must be reset. Such a card is more secure than a conventional transaction card in two common face-to-face transactions. First, if a merchant does not have means to verify that the card number is valid, the card is more secure because the user must correctly enter the PIN to generate the embossed display. (If desired, the card can also include some type of indicator, such as an LED for example, to provide verification of correct entry of the PIN.) Upon generation of the embossed display, the merchant can prove that the card with that display was present for the transaction by making an imprint of the embossed display. Second, even if the merchant does have means to verify that the card number is valid (such as a magnetic stripe reader and a telephone approval mechanism), the card is more secure for the same reason that the user must correctly enter the PIN to generate the embossed display. Moreover, the merchant can check to confirm that the information displayed in the embossed display matches information stored in the magnetic stripe. This extra step is especially important when the card dynamically generates information that is included within the dynamic display, even if an incorrect PIN is entered, instead of using the correct PIN to activate the dynamic display.

Additional security can be built into use of an optical reader and the protocol it uses to read the dynamic display. For example, the dynamic display can contain information about the protocol used to read the display, and the same information can be included in the magnetic stripe. One example of how this might work is that the protocol specifies which bit of a bit string the reader should begin with in reading the number. (E.g., the number might start at bit 25 in the bit string and then wrap around to a lower numbered bit.) When the optical reader is used to read the dynamic display, it can indicate which protocol it used to read the display, and this can be checked against information contained on the magnetic stripe (assuming, in this instance, that the merchant has a magnetic stripe reader).

In a more sophisticated preferred embodiment, the card utilizes a card number generator to generate a user one-time card number, and at least a portion of the one-time card number is displayed in the dynamic display. Such a card provides greater security in situations where a merchant has the means to verify that the one-time card number is valid due to the additional security associated with generation of the one-time card number. Even greater security is provided if a first input is used to generate the one-time card number and a second input is required to activate the dynamic display.

A card that uses a one-time number can use the teachings of the SPECTA system described in U.S. Pat. Nos. 5,913,203, 5,937,394 and 5,956,699, the disclosures of which are all specifically incorporated herein by reference. Additional teachings useful in a card that uses a one-time number are set forth in U.S. application Ser. No. 09/619859 filed Jul. 20, 2000 for Method for Implementing Anonymous Credit Card Transactions Using a Fictitious Account, U.S. application Ser. No. 09/640044 filed Aug. 15, 2000 for Method for Generating Customer One-Time Purchase Order Numbers, and U.S. application Ser. No. 09/659434 filed Sep. 8, 2000 for Method for Generating Customer One-Time Unique Purchase Order Numbers from a Random Number Generator, the disclosures of all of which are specifically incorporated herein by reference.

Details will now be given as to dynamic embossing devices that card 100 can use to create the dynamic display of user information.

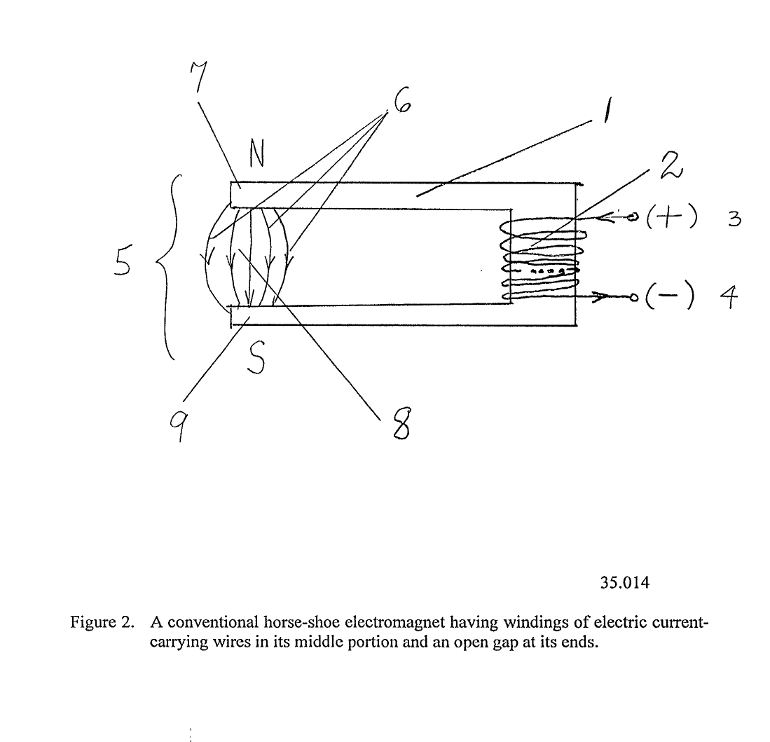

It is well-known in the physics of electromagnetism that when a horseshoe shaped magnetic material such as steel or iron 1 (see FIG. 2) having a winding of electrical wires 2 is energized by passing electrical current through the terminal 3 (positive) and 4 (negative), the structure becomes what is called a horseshoe electromagnet 5. There are magnetic flux lines 6 emanating from one end 7 (North pole) of the gap 8 and ending at the opposite end 9 (South pole). For the polarities of the windings and. current direction as shown in FIG. 2, the ends 7 and 9 of the gap 8 are created as North and South poles, respectively, as indicated by the direction of the magnetic flux lines 6 emanating from end 7 to end 9. Because of the rigidity of the horseshoe shaped magnetic structure, even though the ends tend to attract into each other (opposite poles of a magnet), there is no discernable movement of ends 7 and 9 when the electromagnet 5 is energized.

In a preferred embodiment of the present invention, a horseshoe electromagnet is modified so that one of its ends will bend toward the other end. The end that bends creates a dynamic movement that can move an object that would otherwise make an impression by a card imprinter into a lowered position that will not make such an impression.

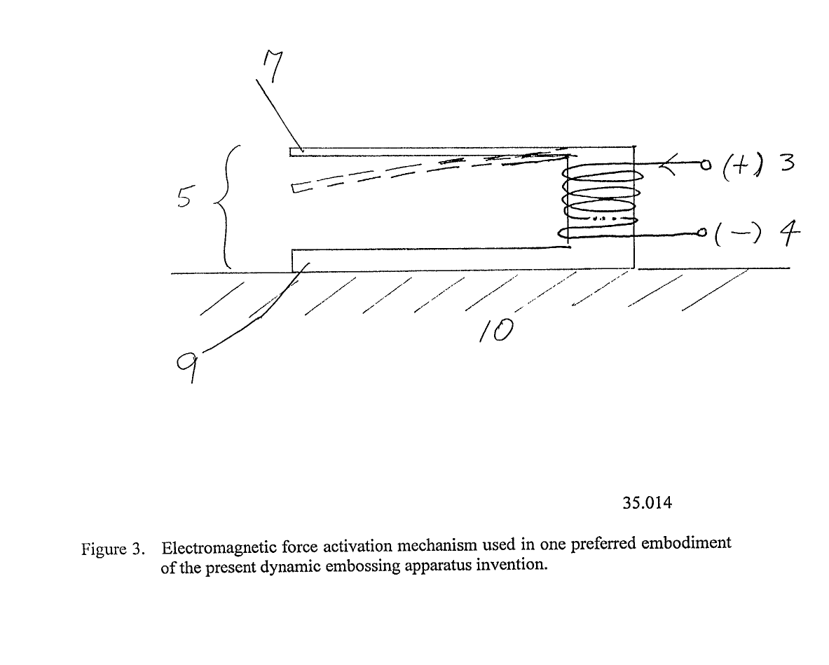

FIG. 3 illustrates operation of an electromagnet used in a preferred embodiment of the present invention. When top end 7 of electromagnet 5 is made very thin (0.005″-0.015″) and the other end 9 is rigidly fastened to surface 10 as shown in FIG. 3, then the tip of end 7 will be deflected towards end 9 upon energizing the electromagnet 5 as illustrated by the dotted line in FIG. 3. This forms the basic activation mechanism for one preferred embodiment of the present invention when electromagnetic force is used.

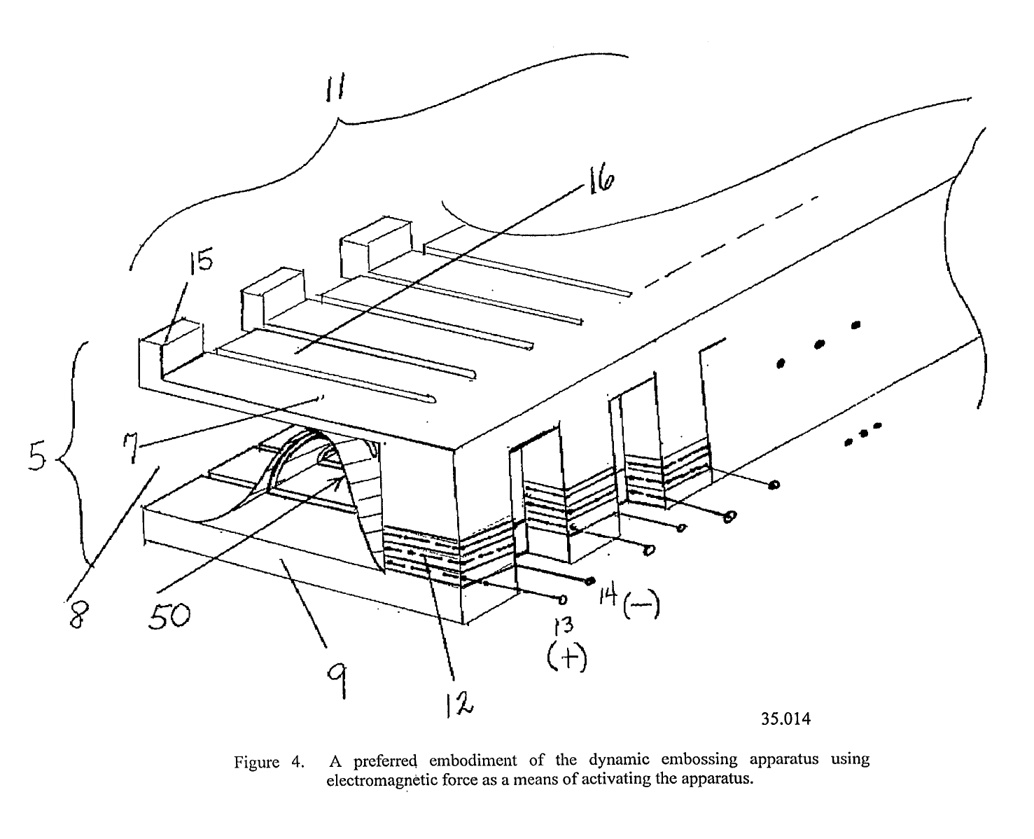

FIG. 4 shows one of the preferred embodiments of the present invention. In this embodiment, the dynamic embossing apparatus 11 is made out of N numbers of electromagnet 5 stacked and connected together in a row to form an N-binary digit embossing unit. “N” here is just an integer number greater then 0 and each electromagnet 5 constitutes a binary bit. The N electromagnet 5 are interstitially separated by a spacer 16. The spacer can be a physical device or a void, such as a slot. The left most electromagnet 5 serves as the least significant binary bit and the right most electromagnet (not shown in FIG. 4) serves as the most significant binary bit. Each electromagnet 5 has a thin upper end 7 (0.005-0.015″ typical) and a heavier bottom end 9 together forming the magnetic gap 8. Each electromagnet 5 also has its individual electrical wire winding 12 (shown as 2 layers of 4 turns each) with terminals 13 (+) and 14 (−) for sending current through the electromagnet 5 in order to energize it. At the extreme end of the thin upper end 7 is a stud 15 which, when the electromagnet 5 is not energized, will be struck by the imprinter head leaving a “dot” on the form paper and indicating as a binary “1”. When the electromagnet 5 is energized, the stud is deflected slightly downwards and missing being struck by the imprinter head and without leaving a “dot” and indicating a binary “0”.

It is preferable, but not absolutely required, that studs 15 be made of the same material as electromagnets 5. The shape and size of a stud 15, and its upper surface, are chosen so that it will perform the function of creating a raised surface discernable by a card imprinter in a non-deflected position, and the function of the spacers is to ensure a better-defined embossing by separating the binary “dots” of studs 15 adequately apart during the imprinting. Accordingly, one skilled in the art will recognize that a spacer may not even be required if adjoining electromagnets 5 are designed to still accomplish the same purpose of providing a sufficient separation of two adjoining studs so as to ensure recognition of the two studs by a reading mechanism when both of the studs are in a non-deflected position.

When an electromagnet is energized to represent a binary “0”, a current pulse typically lasting no more than a few seconds is sent through terminals 13 and 14. Depending upon the permeability of the magnetic materials used to form the embossing apparatus and the number of turns in the windings, the magnitude of the current needed to energize the electromagnet 5 is in the order of a few milliamperes.

The initial or reference state of the dynamic embossing apparatus corresponds to all electromagnets 5 not energized or at a binary “1” state. An adjustable bifurcated spring support 50 is inserted into gap 8 to insure that the swiping motion of a card imprinter will not sufficiently depress studs 15 in an up position so that they will not be imprinted. Such a supportive spring is bifurcated (slotted) in a manner that each of the electromagnets 5 is individually supported for imprinting when it is not energized. When a particular electromagnet 5 is energized to a binary “0” state, only its own supportive spring is sufficiently compressed so that its corresponding stud 15 will be deflected and not be struck for imprinting. Thus, the dynamic embossing apparatus can represent any decimal digit number in the binary format. It can further represent any data, such as alphanumeric, numbers with decimal, integer numbers, numbers with scientific notations etc., as long as each such data can be represented by a string of binary numbers or digits.

The typical dimensions of the dynamic embossing apparatus (shown in FIG. 4) to be used with plastic cards in general or credit cards, such as the SPECTA enabled credit card referred to earlier, is 0.375″wide, 1.000″-1.250″ long and 0.050″ thick.

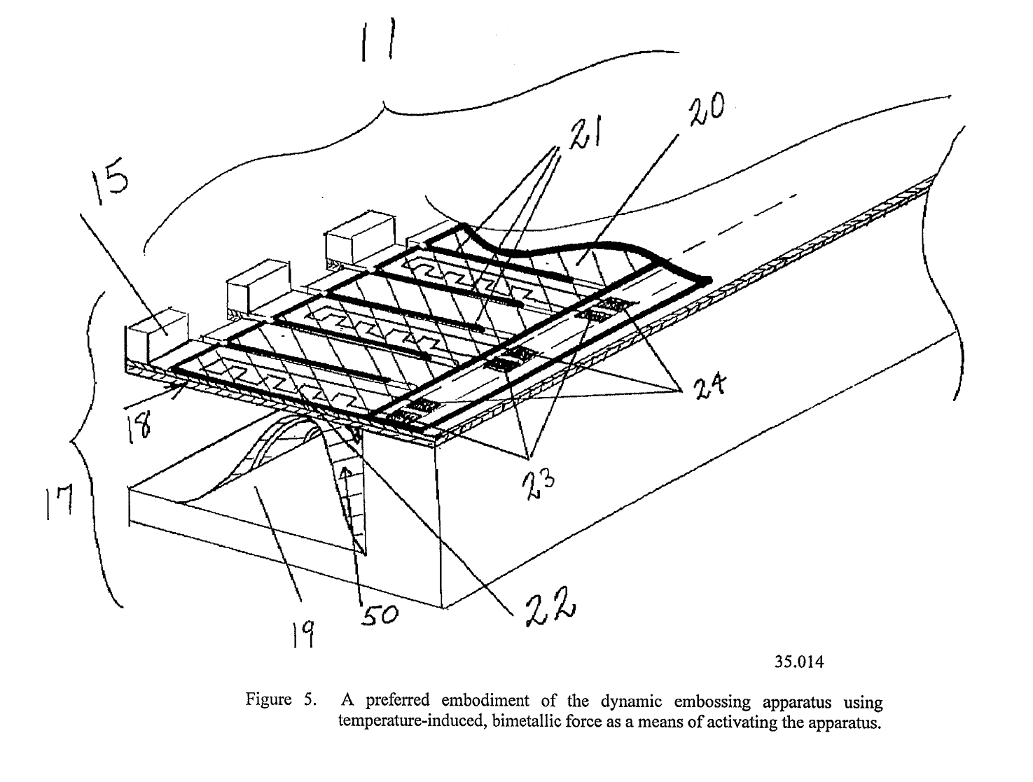

FIG. 5 shows another preferred embodiment of the present invention. In this embodiment, the dynamic embossing apparatus 11 is also made out of N numbers of individual horseshoe shaped units 17 connected together in a row to form an N-binary digit embossing unit. The thin upper part of Unit 17 (0.005-0.015″ typical) is made out of a bimetallic strip 18, such as brass/steel. All the units 17 comprising the N-binary digit embossing unit share the same common base 19. The top part of all the units 17 are thermally bonded to a laminated electrical resistance heater 20 such that through appropriate bifurcations 21, each of the N units will be individually heated by its own resistance heater 22. The laminated electrical resistance heater 20 may use a polymer film of Mylar® or be a polyimide film such as Kapton®. The bimetallic strip 18 serves to deflect the stud 15 at the extreme end of unit 17 downwards when heat is applied to the resistance heater 22 through electrical contact pads 23 and 24. Since the heater is in good thermal contact with the brass component of the bimetallic strip 18, the bimetallic element 18 will bend downwards when heat is applied since brass has a higher linear thermal expansion coefficient than steel. As was the case with the other preferred embodiment, it is preferable, but not required, that stud 15 be made of the same material as unit 17 and that spacers be used to insure sufficient separation of adjoining studs.

The initial or reference state of the dynamic embossing apparatus is when there are no currents flowing in any one of the resistance heaters that are thermally bonded to the top part 7 of the all the units 17. In this state, no studs are deflected downwards. Consequently, the imprinting will yield all N binary “1”'s when the dynamic embossing apparatus is made to be imprinted. Again, an adjustable bifurcated spring support can be inserted into gap 8 to make sure that in this state, no studs will be deflected unintentionally downwards due to the swiping (imprinting) motion of the imprinter (see FIG. 5). It can readily be seen that the dynamic embossing apparatus can represent any data (alphanumeric, decimal or integer numeric etc.) when inputted to it as a string of binary “1” and “0” or as a simple binary number. When a particular unit 17 receives a binary “0” input, electrical current is caused to flow through the resistance heater of that particular unit with the result of deflecting the stud downwards from a “1” to a “0” binary state. Thus, depending on the imprinting results of the dynamic embossing apparatus, the resultant string of “1” and “0” will correctly represent the value of the stored data that is inputted to the dynamic embossing apparatus for imprinting.

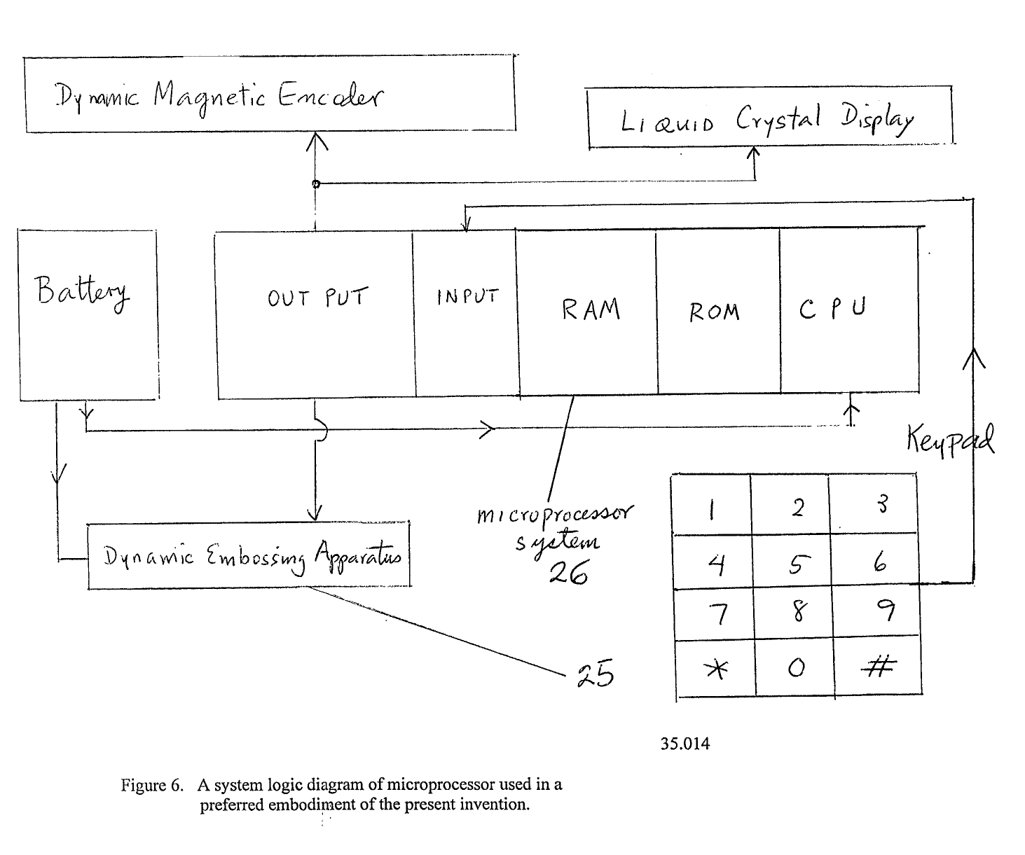

FIG. 6 shows how the present dynamic embossing apparatus 25 can be integrated into the system architecture of the SPECTA enabled card (see above). There are two ways to deploy the present dynamic embossing apparatus 25 to advantage. First, assume that the cardholder's valid credit card number is not openly embossed on the front face of the card but is stored instead in the ROM of microprocessor system 26 (see FIG. 6). Then upon entering the correct password (PIN number) via the keypad 27, the microprocessor system 26 will retrieve the valid credit card number (10 digits only since the first 6 digits of the normal 16-digit credit card is reserved for bank use and are generally embossed on the front face of the card) and outputs it in binary format via the output of the microprocessor system. The dynamic embossing apparatus will take this binary input and activate the corresponding binary digits for imprinting by a card imprinter on a standard credit card form. Note that in this situation, the cardholder's credit card number is not openly embossed on the front of the card for potential misuse and fraud. Only when the correct PIN of the cardholder is entered into the SPECTA enabled card via the keypad will the valid credit card number be made available for imprinting. Thus, the dynamic embossing apparatus eliminates the potential fraud associated with the loss of credit cards because the credit card number is effectively “invisible” and is available for transactions or purchases only when the correct PIN number of the cardholder is entered into said credit card.

As mentioned earlier, many merchants that use a magnetic card reader and accompanying credit card processing infrastructure also invariably imprint the cardholder's credit card for additional personal information. In other words, most cards having a magnetic stripe will still need to have their credit card number, cardholder name, etc. permanently embossed on the front face of the card thus exposing a potential security risk. With the use of the present dynamic embossing apparatus, the merchant is allowed to imprint the personal information from the card only after the correct PIN number is entered into the credit card. Thus, by incorporating this dynamic embossing apparatus into the SPECTA enabled credit card, the merchant can always obtain an imprint of the personal information from the credit card, in this case it is the COUPON number that is also visible from the LCD and stored on the magnetic stripe for the magnetic card reader to read and process. Under this situation, the merchant relies upon the issuer bank to verify the validity of the COUPON number. If this number is approved, the same valid number will also appear on the standard credit card form when the merchant makes an imprint of the card using a standard credit card imprinter.

Although the foregoing detailed description is illustrative of preferred embodiments of the present invention, it is to be understood that additional embodiments thereof will be obvious to those skilled in the art. In addition, the preferred embodiments can be adapted for use in the methods set forth in U.S. application Ser. Nos. 00/667161, 00/667081, 00/667080, 00/667038, and 09/667082, all of which were filed on Sep. 21, 2000 and are specifically incorporated herein by reference. Further modifications are also possible in alternative embodiments without departing from the inventive concept.

Accordingly, it will be apparent to those skilled in the art that still further changes and modifications in the actual concepts described herein can readily be made without departing from the spirit and scope of the disclosed inventions as defined by the following claims.

What is claimed is:

1. A card with an embossed display of user information, comprising:
a card having an input device;
a logic device that generates an activation signal when an input received by the input device satisfies an activation condition; and
a dynamic embossing device for completing the embossed display of user information in response to the activation signal.

2. A card as recited in claim 1, wherein the dynamic embossing device uses an electromagnetic force activation mechanism.

3. A card as recited in claim 2, wherein the dynamic embossing device is comprised of a plurality of electromagnets.

4. A card as recited in claim 3, wherein each of the plurality of electromagnets is comprised of:
a horseshoe shaped magnetic material having an upper end with a stud, a lower end, and a winding of wires that can be energized by passing electrical current through a positive and a negative terminal to cause the stud to move from a non-deflected position to a deflected position.

5. A card as recited in claim 4, wherein the stud protrudes upwardly from an upper surface of the upper end and is readable as part of the embossed display when it is in the non-deflected position but is not readable as part of the embossed display when it is in the deflected position.

6. A card as recited in claim 5, wherein a spacer interstitially separates each pair of the plurality of electromagnets.

7. A card as recited in claim 6, wherein the spacer is a physical divider.

8. A card as recited in claim 6, wherein the spacer is a slot.

9. A card as recited in claim 6, wherein the spacer is sized so as to provide a sufficient separation of two studs separated by the spacer and ensure recognition of the two studs by a reading mechanism when both of the studs are in a non-deflected position.

10. A card as recited in claim 9, wherein the reading mechanism is a card imprinter.

11. A card as recited in claim 10, further comprising a spring support that biases the stud of each of the plurality of electromagnets toward the non-deflected position when each such stud is in the non-deflected position and is being read by the card imprinter.

12. A card as recited in claim 5, wherein the stud is located proximate to a tip of the upper end.

13. A card as recited in claim 5, wherein the lower end of each of the plurality of electromagnets is affixed to a surface of the card.

14. A card as recited in claim 13, wherein the thickness of the upper and the lower ends of each of the plurality of electromagnets is such that when the lower end is secured to a rigid surface so that it will not move, the upper end will deflect toward the lower, secured end.

15. A card as recited in claim 1, wherein the dynamic embossing device uses a temperature-induced, bimetallic bending force activation mechanism.

16. A card as recited in claim 15, wherein the dynamic embossing device is comprised of a plurality of bimetallic strips and a heater that can individually heat each of the plurality of bimetallic strips, wherein each of the plurality of bimetallic strips has a stud.

17. A card as recited in claim 16, wherein the heater is a laminated polyimide electrical resistance heater.

18. A card as recited in claim 17, wherein a top part of each of the plurality of bimetallic strips is bonded to the laminated polyimide electrical resistance heater.

19. A card as recited in claim 16, wherein the heater is a bifurcated heater that can individually heat each of the plurality of bimetallic strips.

20. A card as recited in claim 19, wherein the plurality of bimetallic strips are formed from a single sheet of bimetallic metal and each of the strips is separated from at least one adjacent strip by an interstitial spacer such that it can move between a non-deflected position and a deflected position independent of any adjacent strip.

21. A card as recited in claim 16, wherein the stud protrudes upwardly from an upper surface of the bimetallic strip and is readable as part of the embossed display when it is in the non-deflected position but is not readable as part of the embossed display when it is in the deflected position.

22. A card as recited in claim 21, wherein a spacer interstitially separates each pair of the plurality of bimetallic strips.

23. A card as recited in claim 22, wherein the spacer is a physical divider.

24. A card as recited in claim 22, wherein the spacer is a slot.

25. A card as recited in claim 22, wherein the spacer is sized so as to provide a sufficient separation of two studs separated by the spacer and ensure recognition of the two studs by a reading mechanism when both of the studs are in a non-deflected position.

26. A card as recited in claim 25, wherein the reading mechanism is a card imprinter.

27. A card as recited in claim 26, further comprising a spring support that biases the stud of each of the plurality of bimetallic strips toward the non-deflected position when each such stud is in the non-deflected position and is being read by the card imprinter.

28. A card as recited in claim 16, wherein the stud is located proximate to a tip of the upper end.

29. A card as recited in claim 1, wherein the embossed display of user information is comprised of:
a fixed display of user information; and
a dynamic display of user information that is activated by the dynamic embossing device in response to the activation signal.

30. A card as recited in claim 29, wherein the dynamic display is in a binary format.

31. A card as recited in claim 29, wherein the dynamic display is in an alphanumeric format.

32. A card as recited in claim 29, wherein the dynamic display is in a numeric format.

33. A card as recited in claim 1, wherein the activation condition is that the input matches a stored activation input.

34. A card as recited in claim 1, wherein the input device is a keypad.

35. A card as recited in claim 1, wherein the input device is a wireless device.

36. A card as recited in claim 1, wherein the input is a user key.

37. A card as recited in claim 1, wherein the embossed display of information contains a transaction card number.

38. A card as recited in claim 37, wherein the transaction card number is a user one-time card number.

39. A card as recited in claim 38, wherein the logic device generates the user one-time card number.

40. A card as recited in claim 39, wherein the input is used to generate the one-time card number.

41. A card as recited in claim 39, wherein a second input received by the input device is used to generate the one-time card number.

42. A card as recited in claim 39, wherein the transaction card is a credit card and the user one-time card number is a credit card number.

43. A card as recited in claim 42, wherein the fixed display of user information includes a user name.

44. A card as recited in claim 42, wherein the fixed display of user information includes a fictitious user name.
